(19) United States
(12) Patent Application Publication
(10) Pub. No.: US 2022/0298615 A1
(43) Pub. Date: Sep. 22, 2022

(54) Methods of Modifying a Domain Structure of a Magnetic Ribbon, Manufacturing an Apparatus, and Magnetic Ribbon Having a Domain Structure

(71) Applicants: Paul Richard Ohodnicki, JR., Allison Park, PA (US); Alex Leary, Cleveland, OH (US); Randy R. Bowman, Valley City, OH (US); Ronald D. Noebe, Medina, OH (US); Grant E. Feichter, Massillon, OH (US); Carnegie Mellon University, Pittsburgh, PA (US)

(72) Inventors: Paul Richard Ohodnicki, Jr., Allison Park, PA (US); Alex Leary, Cleveland, OH (US); Randy R. Bowman, Valley City, OH (US); Ronald D. Noebe, Medina, OH (US); Grant E. Feichter, Massillon, OH (US); Michael Edward McHenry, Pittsburgh, PA (US); Kevin Byerly, Pittsburgh, PA (US); Vladimir Keylin, Cleveland, OH (US)

(21) Appl. No.: 17/626,626

(22) PCT Filed: Jul. 10, 2020
(86) PCT No.: PCT/US2020/041558

§ 371 Date: Jan. 12, 2022

Related U.S. Application Data
(60) Provisional application No. 62/921,887, filed on Jul. 12, 2019.

(51) Int. Cl. C22F 1/10; H01F 41/02; H02K 15/02; C22C 19/07

(52) U.S. Cl. CPC C22F 1/10; H01F 41/02; H02K 15/02; C22C 19/07; C22C 2202/02

(57) ABSTRACT

A method of modifying a domain structure of a magnetic ribbon is provided. The method includes a combination of stress and magnetic field annealing the magnetic ribbon in order to generate a desired permeability along one or more axes of the magnetic ribbon.

### CROSS REFERENCE TO RELATED APPLICATION

This application claims priority to U.S. Provisional Patent Application No. 62/921,887, filed Jul. 12, 2019, the disclosure of which is hereby incorporated by reference in its entirety.

### STATEMENT REGARDING FEDERALLY SPONSORED RESEARCH

This invention was made with government support under contract DE-EE0007464 awarded by the Department of Energy. The government has certain rights in the invention.

### BACKGROUND OF THE INVENTION

### Field of the Invention

The disclosed concept relates to methods of modifying a domain structure of a magnetic ribbon. The disclosed concept further relates to methods of manufacturing an apparatus. The disclosed concept further relates to magnetic ribbons having a domain structure.

### Technical Considerations

Apparatuses having magnetic core architectures may be formed from tape wound core materials, such as magnetic ribbons. Apparatuses that include magnetic cores made from magnetic ribbons include transformers, inductors, sensors, motor rotors, motor stators, and the like. The magnetic core material has an atomic structure that strongly influences the structure of magnetic spins that is often described as a magnetic domain structure. These domain structures can introduce complex magnetization processes which may affect losses associated with dynamic magnetization processes.

The primary function of soft magnetic materials in many applications is to provide inductive impedance while minimizing losses. Often, applications require materials with a specific hysteresis shape, including square hysteresis loops with high permeability and flat, or sheared hysteresis loops with permeability tuned to a specific value. The hysteresis loop shape can be engineered by introducing magnetic anisotropies into the material through processing. For sheared loops, this method is often preferable compared to lowering permeability through the use of introducing air gaps in the magnetic path. The magnitude and orientation, or symmetry, of the induced anisotropies affect the magnetic domain structures that determine the magnetization state. Eddy currents driven by the excitation field in conductive magnetic material and the irregular motion of domain walls contribute to loss mechanisms.

It is therefore desirable to provide for an improved method of modifying a domain structure of a magnetic ribbon, a method of manufacturing an apparatus, and a magnetic ribbon having a domain structure.

### SUMMARY OF THE INVENTION

In one aspect, a method of modifying a domain structure of a magnetic ribbon is provided. The method comprises a combination of stress and magnetic field annealing the magnetic ribbon in order to generate a desired permeability along one or more axes of the magnetic ribbon.

In another aspect, a method of manufacturing an apparatus is provided. The method comprises a combination of stress and magnetic field annealing a magnetic ribbon in order to generate a desired permeability along one or more axis of the magnetic ribbon, and forming the magnetic ribbon into the apparatus. The apparatus is selected from the group consisting of a transformer, an inductor, a sensor, a motor rotor, and a motor stator.

In another aspect, a magnetic ribbon having a domain structure is provided. The magnetic ribbon comprises a metal amorphous nanocomposite (MANC) alloy ribbon having an anisotropic fault structure within close packed atoms of the ribbon, giving rise to a predefined permeability for excitation fields applied along an axis of the ribbon, and another axis of permeability different than the predefined permeability, within a plane of the ribbon, and transverse to the longitudinal axis.

Further embodiments or aspects are set forth in the following numbered clauses:

Clause 1. A method of modifying a domain structure of a magnetic ribbon, comprising: a combination of stress and magnetic field annealing the magnetic ribbon in order to generate a desired permeability along one or more axes of the magnetic ribbon.

Clause 2. The method according to clause 1, wherein the combination further comprises stress annealing the magnetic ribbon in order to generate the desired permeability along a longitudinal axis of the magnetic ribbon, and annealing the magnetic ribbon in a magnetic field along the longitudinal axis of the magnetic ribbon.

Clause 3. The method according to clause 1 or 2, wherein the combination further comprises stress annealing the magnetic ribbon in order to generate the desired permeability along a longitudinal axis of the magnetic ribbon, and annealing the magnetic ribbon in a magnetic field transverse to the longitudinal axis of the magnetic ribbon.

Clause 4. The method according to clauses 1-3, wherein the combination further comprises annealing the magnetic ribbon in a magnetic field such that a desired material response produced by annealing the magnetic ribbon in the magnetic field is generally not collinear with the magnetic field.

Clause 5. The method according to clauses 1-4, further comprising applying a manufactured die on a surface of the magnetic ribbon with a thermal expansion mismatch at elevated temperatures in order to generate a desired stress distribution and orientation dependent permeability, and annealing the ribbon in a rotating magnetic field within a plane of the magnetic ribbon.

Clause 6. The method according to clauses 1-5, further comprising heating the manufactured die and pressing the manufactured die into the surface of the magnetic ribbon in order to apply stress.

Clause 7. The method according to clauses 1-6, further comprising employing a MANC alloy material as the magnetic ribbon.

Clause 8. The method according to clauses 1-7, wherein the MANC alloy is a Cobalt-rich MANC alloy.

Clause 9. The method according to clauses 1-8, further comprising generating the desired permeability in the magnetic ribbon such that the magnetic ribbon exhibits a nanocomposite structure following the combination of stress and magnetic field annealing.

Clause 10. The method according to clauses 1-9, further comprising annealing the magnetic ribbon in the magnetic field at temperatures at or below temperatures utilized during the stress annealing in order to reduce high frequency losses by optimizing the domain structure of the magnetic ribbon without substantially affecting the desired permeability.

Clause 11. The method according to clauses 1-10, further comprising annealing the magnetic ribbon in a magnetic field at temperatures above temperatures utilized during the stress annealing.

Clause 12. The method according to clauses 1-11, further comprising simultaneously stress and magnetic field annealing the magnetic ribbon.

Clause 13. The method according to clauses 1-12, further comprising stress annealing the magnetic ribbon with a thermal process zone via direct conduction.

Clause 14. The method according to clauses 1-13, further comprising stress annealing the magnetic ribbon with a thermal process zone via convection.

Clause 15. The method according to clauses 1-14, further comprising stress annealing the magnetic ribbon with a thermal process zone via induction annealing in order to allow for ease of access of magnetic field to the process zone.

Clause 16. The method according to clauses 1-15, further comprising stress annealing the magnetic ribbon with a thermal process zone via susceptor based induction annealing in order to allow for ease of access of magnetic field to the process zone.

Clause 17. The method according to clauses 1-16, further comprising stress annealing the magnetic ribbon with a thermal process zone via radiation, including via one of laser and heat lamps, processing annealing, in order to allow for ease of access of magnetic field to the process zone.

Clause 18. The method according to clauses 1-17, further comprising annealing the magnetic ribbon in a magnetic field such that the magnetic ribbon forms a part of a magnetic path, thereby reducing a maximum magnitude, a spatial extent, and a uniformity of the magnetic field required to generate the desired permeability.

Clause 19. The method according to clauses 1-18, further comprising annealing the magnetic ribbon in a magnetic field such that the intensity of the magnetic field is substantially independent of the magnetic ribbon, thereby ensuring a uniform and large magnetic field, even as the annealing is conducted at, near, or above a Curie temperature.

Clause 20. The method according to clauses 1-19, further comprising annealing the magnetic ribbon in a magnetic field such that at least one of a crystalline phase and an amorphous phase of the magnetic ribbon has a Curie temperature higher than a processing temperature of the magnetic field.

Clause 21. The method according to clauses 1-20, wherein the stress annealing comprises applying compressive stresses to a surface of the magnetic ribbon.

Clause 22. The method according to clauses 1-21, wherein the stress annealing comprises applying tensile stresses to a surface of the magnetic ribbon along a longitudinal axis of the magnetic ribbon.

Clause 23. The method according to clauses 1-22, wherein the stress annealing comprises applying stresses to at least one surface of isolated pieces produced from the magnetic ribbon, the stresses being of tensile and/or compressive nature.

Clause 24. The method according to clauses 1-23, further comprising developing a desired anisotropy pattern in the magnetic ribbon by sequentially treating sections of the magnetic ribbon over a surface using localized heating, varied magnitudes, directions of stresses, and magnetic fields.

Clause 25. The method according to clauses 1-24, further comprising forming the magnetic ribbon into a tape wound core before magnetic field annealing the magnetic ribbon.

Clause 26. The method according to clauses 1-25, wherein the desired permeability varies over a length of the magnetic ribbon.

Clause 27. A method of manufacturing an apparatus, comprising: a combination of stress and magnetic field annealing a magnetic ribbon in order to generate a desired permeability along one or more axis of the magnetic ribbon; and forming the magnetic ribbon into the apparatus, wherein the apparatus is selected from the group consisting of a transformer, an inductor, a sensor, a motor rotor, and a motor stator.

Clause 28. A magnetic ribbon having a domain structure, comprising: a MANC alloy ribbon having an anisotropic fault structure within closely packed nanocrystals of the ribbon, giving rise to a predefined permeability for excitation fields applied along a longitudinal axis of the ribbon, and another axis of permeability different than the predefined permeability, within a plane of the ribbon, and transverse to the longitudinal axis.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic illustrating a magnetic ribbon having two axes along which non-limiting annealing processes may be applied, in accordance with one non-limiting embodiment of the disclosed concept;

FIG. 2 is an image of a domain structure pattern of an alloy after stress annealing;

FIG. 3 is an image of a domain structure of an alloy after stress annealing followed by transverse magnetic field annealing;

FIGS. 4a-4d are graphs of a measured core loss as a function of saturation flux density (B) at a fixed excitation frequency of 2 kHz for four samples;

FIG. 4e shows the relative permeability after annealing with stress only, and stress plus transverse magnetic field (TMF) annealing, based on the graphs of FIGS. 4a-4d; and

FIG. 5 is a chart of non-limiting methods for modifying the domain structure of a magnetic ribbon.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

All numbers used in the specification and claims are to be understood as being modified in all instances by the term “about.” The terms “approximately,” “about,” and “substantially” mean a range of plus or minus ten percent of the stated value.

As used herein, the term “metal amorphous nanocomposite material” (MANC) refers to soft magnetic materials (SMMs) featuring low power loss at high frequency and maintaining relatively high flux density. MANCs have metastable nanocomposite structures, which may remain stable to several 100° C. without deleterious secondary crystallization or deterioration of magnetic properties. As an example, a MANC may include an FeNi-based composition. A MANC may include a Cobalt (Co)-based composition. Suitable materials are described in U.S. Patent Application Publication No. 2019/0368013 (application Ser. No. 16/434,869), titled “Fe—Ni Nanocomposite Alloys,” as well as U.S. Pat. No. 10,168,392 (application Ser. No. 14/278,836), titled “Tunable anisotropy of co-based nanocomposites for magnetic field sensing and inductor applications,” the entirety of which are hereby incorporated by reference.

As employed herein, the term “permeability,” denoted by the letter “μ,” shall mean the material property that relates the change in magnetic flux density B, as measured along a direction parallel to the excitation field H. This is the commonly used relative permeability μᵣ that is normalized by the permeability of free space μₒ so that B=μᵣμ₀ H. Core losses, sometimes described using a complex permeability term, are described separately so that permeability here is a real valued property.

As employed herein, the phrase “excitation fields” shall mean magnetic fields H applied to the soft magnetic material through the use of wound coils and/or nearby magnetic materials that produce their own respective field.

As employed herein, the term “Cobalt-rich” shall mean a nanocomposite comprising cobalt (Co), 30 atomic % or less of Iron (Fe) or Nickel (Ni), and 50 atomic % or less of one or more metals selected from the group comprising boron (B), carbon (C), phosphorous (P), silicon (Si), chromium (Cr), tantalum (Ta), niobium (Nb), vanadium (V), copper (Cu), aluminum (Al), molybdenum (Mo), manganese (Mn), tungsten (W), and zirconium (Zr).

The disclosed concept is directed to apparatuses including improved magnetic core architectures based on tape wound core materials with low loss switching, for higher effective efficiencies. The apparatus may be, without limitation, a transformer, an inductor, a sensor, a motor rotor, and a motor stator. The cores may include one or more magnetic ribbons having one or more MANC alloy materials. The magnetic ribbon may include any MANC alloy known in the art (e.g., without limitation, a Cobalt rich MANC alloy). The magnetic ribbon may be produced using various processes, such as rapid solidification processing, which results in the magnetic ribbon being particularly suitable for one or more annealing processes.

In accordance with the disclosed concept, the magnetic ribbon may have a modified domain structure such that a desired fault structure is achieved which ensures a dominant rotation magnetization process in a plane parallel to the ribbon surface. The dominant rotation magnetization process achieved by the desired domain structure may result in a reduction in hysteretic and eddy current losses associated with domain wall motion. The desired anisotropic atomic structure can be obtained by various processing techniques that act on various mechanisms in the material. Each mechanism has an associated activation energy, so that the magnitude and direction of the anisotropy can be controlled through the characteristic time and strength of thermal, magnetic, and or mechanical energies applied during processing. The domain structure at a given time relates to the domain wall structure and domain orientations that minimize the total energy in the material for the excitation field at that instant.

The domain structure of the magnetic ribbon may be modified by, for example, one or more annealing processes applied to the magnetic ribbon. The disclosed concept contemplates that the magnetic ribbon undergoes mechanical stress annealing to create intentional anisotropy, to generate a desired permeability, and/or to generate nanocomposite structures in the magnetic ribbon. The magnetic ribbon may also undergo magnetic field annealing in the presence of a magnetic field to modify the domain structure. The anisotropy distribution of a processing step can produce the desired permeability for an application, but an unfavorable domain structure that leads to high core losses. For example, uniaxial magnetic field annealing of the magnetic ribbon creates anisotropy where the induced easy axis is defined by the uniaxial field and associated domain structures can be simple stripe or bar domains. Stress annealing can produce anisotropies related to the symmetries of the magnetoelastic coupling or fault mechanisms, that are not generally uniaxial, and that form more complex surface domain structures. The higher energy densities available for practical stress annealing processing methods allows for higher induced anisotropies, but generally with larger distributions, compared to practical field annealing processing methods. The domain structure of the magnetic ribbon may be modified using a method including a combination of stress annealing and magnetic field annealing the magnetic ribbon in order to generate a desired permeability along one or more axes of the magnetic ribbon. Stress annealing and magnetic field annealing may generate the desired permeability in the magnetic ribbon such that the magnetic ribbon exhibits a nanocomposite structure following the combination of stress annealing and magnetic field annealing.

The stress annealing and/or magnetic field annealing processes described herein are advantageously performed to create improved properties. Specifically, the modifications of the domain structure of the magnetic ribbon may reduce the complex domain arrangements that are visible on the surface of the ribbon, which may enable low switching losses for higher effective efficiencies of magnet cores, improving overall material and component performances.

The permeability of the magnetic ribbon developed using the abovementioned one or more annealing processes may be constant throughout the magnetic ribbon. Alternatively, the desired permeability may vary over a length of the magnetic ribbon. Modifying the domain structure of a magnetic ribbon may be suitable for use in certain inductors that require a low permeability. In order to have a varying permeability in the magnetic ribbon, the strength and/or direction of the annealing processes may be varied to develop a tunable anisotropy. For example, a desired anisotropy pattern may be developed in the magnetic ribbon by sequentially treating sections of the magnetic ribbon over a surface using localized heating, varied magnitudes, directions of stresses, and magnetic fields.

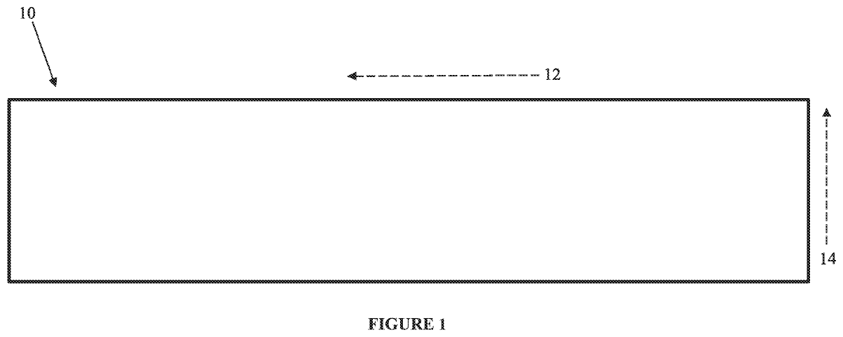

Additionally, stress annealing may be performed on the material in the presence of one or more external stresses. Non-limiting examples of external stresses that may be applied to the material during stress annealing are tensile stresses and/or compressive stresses. FIG. 1 shows a magnetic ribbon 10 having two axes 12, 14 along which non-limiting annealing processes may be performed. The magnetic ribbon has a longitudinal axis 12, which corresponds to the ribbon axis, and an axis 14, which is transverse to the longitudinal axis. The magnetic ribbon may undergo stress annealing where tensile stresses are applied to a surface of the magnetic ribbon along the longitudinal axis 12 of the magnetic ribbon (i.e., the ribbon axis). As another example, the magnetic ribbon may undergo stress annealing where compressive stresses are applied to the surface of the magnetic ribbon. During stress annealing, stresses may be applied to at least one surface of isolated pieces produced from the magnetic ribbon, the stresses being of tensile and/or compressive nature.

The magnetic ribbon may undergo stress annealing under standard thermal processing zones. Standard thermal processing zones may apply heat to the material through conduction and/or convention. Furthermore, standard thermal processing zones may apply heat to the material through induction, susceptor based induction, and radiation. The magnetic ribbon may undergo stress annealing under thermal processing zones via induction annealing, wherein thermal processing zones allow for ease of access of a magnetic field to the process zone. The magnetic ribbon may also undergo stress annealing under thermal processing zones via susceptor based induction annealing, wherein thermal processing zones allow for ease of access and control of the excitation field within to the process zone. The magnetic ribbon may also undergo stress annealing under thermal processing zones via radiation. Non-limiting examples of suitable radiation methods include laser and heat lamps, processing annealing, and the like. Thermal processing zones via radiation, using any of the aforementioned methods and/or the like, may allow for ease of access of a magnetic field to the process zone. The thermal energy can be applied uniformly over length scales equal to or larger than the application core or varied over lengths scales smaller than the application core. These characteristic length scales are referred to as global and local length scales of the relevant processing.

Regarding annealing the magnetic ribbon in a magnetic field, the magnetic field may be applied in any direction relative to the ribbon axis in both global and local length scales. For example, a magnetic field applied during annealing may be applied to the axis 14, transverse to the longitudinal axis of the magnetic ribbon (i.e., the ribbon axis). As another example, a magnetic field may be applied along the longitudinal axis 12. Magnetic field annealing may be performed on the magnetic ribbon at any suitable annealing temperature for the material. Specifically, magnetic field annealing may be performed on the magnetic ribbon at or below temperatures utilized during the stress annealing in order to reduce high frequency losses by optimizing the domain structure of the magnetic ribbon without substantially affecting the desired permeability. Alternatively, magnetic field annealing may be performed on the magnetic ribbon at temperatures above temperatures utilized during the stress annealing. Moreover, the magnetic field applied to the magnetic ribbon may be stationary or may be a rotating magnetic field.

The magnetic ribbon may be placed at a predetermined distance from the magnetic field during annealing, a predetermined distance proportional to the size of the magnetic ribbon. The magnetic ribbon may be in the in the magnetic field path such that the magnetic ribbon closes the magnetic flux path of the magnetic field. The magnetic field may have a predetermined strength, which may be low enough that the magnetic field must rely on the material to close the magnetic flux path. Furthermore, the magnetic ribbon may form a part of the magnetic path of the magnetic field, thereby reducing the maximum magnitude, the spatial extent, and the uniformity of the magnetic field required to generate a desired permeability of the magnetic ribbon. Additionally, the magnetic field source may reach the desired field strength when the magnetic ribbon is not part of the magnetic field path between the two poles. If the magnetic ribbon is part of the magnetic field path length, the magnetic field may break down if the ribbon reluctance increases at annealing temperatures approaching or exceeding the Curie temperatures of the phases contained within the ribbon. The magnetic ribbon may be annealed in a magnetic field such that a desired material response produced by annealing the magnetic ribbon in the magnetic field is generally not collinear with the magnetic field. For example, the ribbon may be field annealed in the transverse orientation but used in application with the field applied in the longitudinal orientation.

The magnetic ribbon may be annealed in the presence of a magnetic field such that the intensity of the magnetic field is substantially independent of the magnetic ribbon, thereby ensuring a uniform and large magnetic field, even when annealing is conducted at or above the Curie temperature of the magnetic ribbon. The magnetic ribbon may also be annealed in a magnetic field such that at least one of a crystalline phase and an amorphous phase of the magnetic ribbon has a Curie temperature higher than a processing temperature of the magnetic ribbon. The strongest coupling to anisotropy mechanisms related to field annealing typically occurs when at least one phase is ferromagnetic at the processing temperature.

Magnetic field annealing may be performed on the magnetic ribbon using one or more furnaces. A first furnace may apply a global magnetic field to the magnetic ribbon. A second furnace may apply a local magnetic field. The magnetic ribbon may be within the magnetic field path of the magnetic field produced by the second furnace such that the magnetic ribbon is part of the magnetic flux path. Moreover, the magnetic ribbon may be part of the magnetic field path such that the magnetic ribbon closes the magnetic flux path.

The magnetic ribbon may also undergo both stress annealing and magnetic field annealing simultaneously. The simultaneous application of stress annealing and magnetic field annealing may result in a magnetic ribbon with a greater reduction in effective switching losses for a given permeability compared to if the magnetic ribbon was only subject to stress annealing. As another example, the magnetic ribbon may undergo stress annealing and magnetic field annealing in a predetermined order, such as stress annealing followed by magnetic field annealing or magnetic field annealing followed by stress annealing.

If one or more annealing processes are to be performed in a predetermined order, there may be a predetermined time between each of the annealing processes related to the activation energies of the anisotropy mechanisms. For example, the magnetic ribbon may undergo a first annealing process followed by a second annealing process with a predetermined amount of time between the first annealing process and the second annealing process. The amount of time may be sufficient to allow the magnetic ribbon to cool from an annealing temperature to a specified temperature. However, anisotropy mechanisms can relax faster at elevated temperatures compared to temperatures close to 25° C. if the stress or field is removed.

Stress annealing may be used in order to tailor the magnetic anisotropy of the magnetic ribbon, such as by adjusting the average and spatially varying permeability to specific values for specific inductive component applications. Subjecting a magnetic ribbon to stress annealing may result in a magnetic ribbon having a relatively large anisotropy.

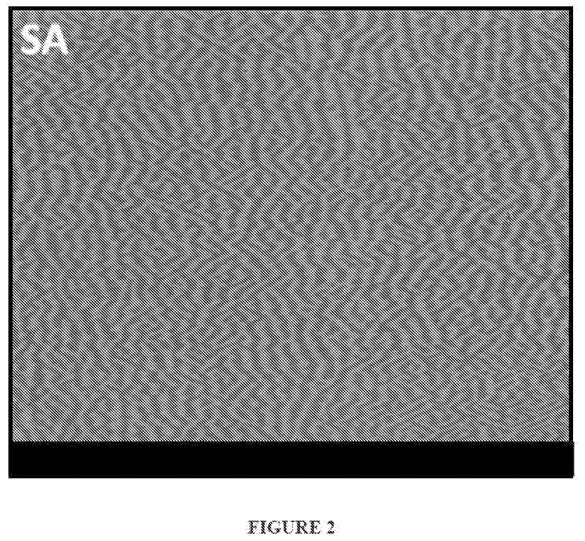

FIG. 2 is a magneto-optical Kerr effect image taken by an optical microscope showing a Co-rich magnetic ribbon after annealing under a tensile stress only. As shown in FIG. 2, the magnetic ribbon has a finely spaced domain structure. The domain structure of the magnetic ribbon may be indicative surface closure domains covering bulk domains with magnetization components out of the plane of the magnetic ribbon. The domain structure of the magnetic ribbon may also be indicative of stress that is coupled to magneto-striction. This domain structure can produce linear permeability over a wide range of excitation fields, but generally leads to increased losses.

Magnetic field annealing may be used to narrow the anisotropy distribution and create striped domain structures, where the magnetization lies in the ribbon plane. For applications requiring flat loops, the desired domain structure is striped or bar domains with domain walls oriented parallel to the transverse axis. Striped domain structures can be created such that magnetization changes by rotational processes and domain wall movement are not dominant. Optimizing the domain structure of the magnet ribbon using magnetic field annealing may result in a reduction in high frequency losses. If the magnetic ribbon has a predetermined permeability generated from a previous process, such as stress annealing, the magnetic field annealing is then able to optimize the domain structure of the magnetic ribbon without substantially affecting the previously established permeability. However, processing methods may also be chosen that change the permeability after each annealing step, if performed in sequence.

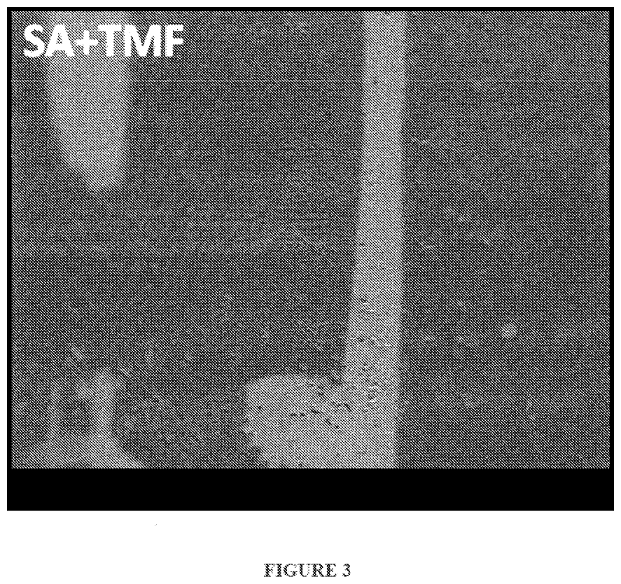

FIG. 3 is a magneto-optical Kerr effect image taken by an optical microscope showing a magnetic ribbon after the same stress annealing treatment of FIG. 2, followed by a transverse magnetic field annealing step. As shown in FIG. 3, the magnetic ribbon has a relatively large domain structure. The relatively large domain structure of the magnetic ribbon is indicative of the magnetization vector of the material being positioned parallel to the plane of the magnetic ribbon. The domain structure deviates from the ideal bar domain structure due to shape anisotropy effects in the sample.

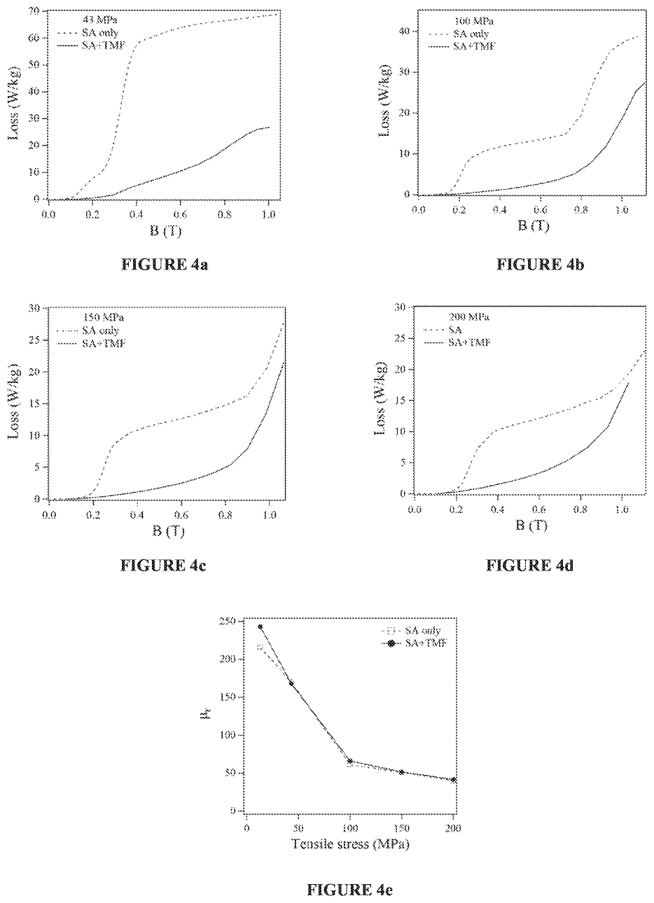

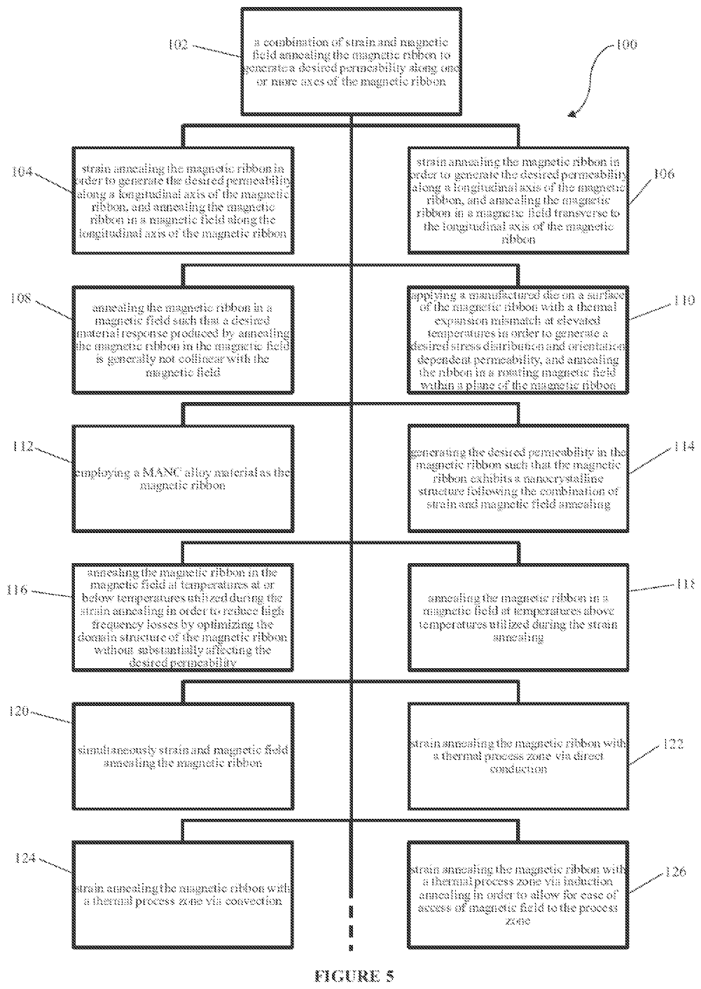

FIGS. 4a-4d are graphs of a measured core loss as a function of saturation flux density (B) at a fixed excitation frequency of 2 kHz for four samples. Each sample was first stress annealed under tension at different values (43, 100, 150, and 200 MPa for FIGS. 4a-4d, respectively) at 500 C at a rate of 6 ft/min through a 1 ft heat zone. Tapewound toroids were produced from these ribbons and core losses measured under sinusoidal field excitation. These same tape wound cores then underwent a second transverse magnetic field annealing step. As shown in the graphs of FIGS. 4a-4d, the core loss associated with the sample that underwent both stress annealing and magnetic field annealing was significantly less than the core loss associated with the sample that underwent only stress annealing. By also subjecting the magnetic ribbon to magnetic field annealing, the fault distribution of the domain structure of the magnetic ribbon may be refined to reduce the overall core loss without significantly effecting the defined permeability produced from the previous stress annealing.

FIG. 4e shows the relative permeability after annealing with stress only, and stress plus transverse magnetic field (TMF) annealing. These permeabilities at each stress value correspond to the loss data shown for the 2 kHz cases of FIGS. 4a-4d. For this processing, permeability increases slightly after the second annealing step compared to the first step for each core.

Furthermore, a step of applying a manufactured die to the surface of the magnetic ribbon may be performed. The manufactured die: a) may have a thermal expansion mismatch at elevated temperatures with the magnetic ribbon; b) may undergo a step of being heated to a specified temperature and pressed into the surface of the magnetic ribbon in order to apply stress; c) may be applied to the surface of the magnetic ribbon in order to generate a desired stress distribution and orientation dependent permeability; and d) may be applied to the surface of the magnetic ribbon before, during, or after any of the methods as described herein, e.g., applied to the surface of the magnetic ribbon and then the magnetic ribbon may undergo a step of being annealed in a rotating magnetic field within a plane of the magnetic field.

The magnetic ribbon formed from the processes described herein may have a predefined permeability for excitation fields applied along a longitudinal axis of the ribbon, another axis of permeability different than the predefined permeability, within a plane of the ribbon, and transverse to the longitudinal axis. The magnetic ribbon may be formed into a tape wound core before, after, or in between any of the annealing processes.

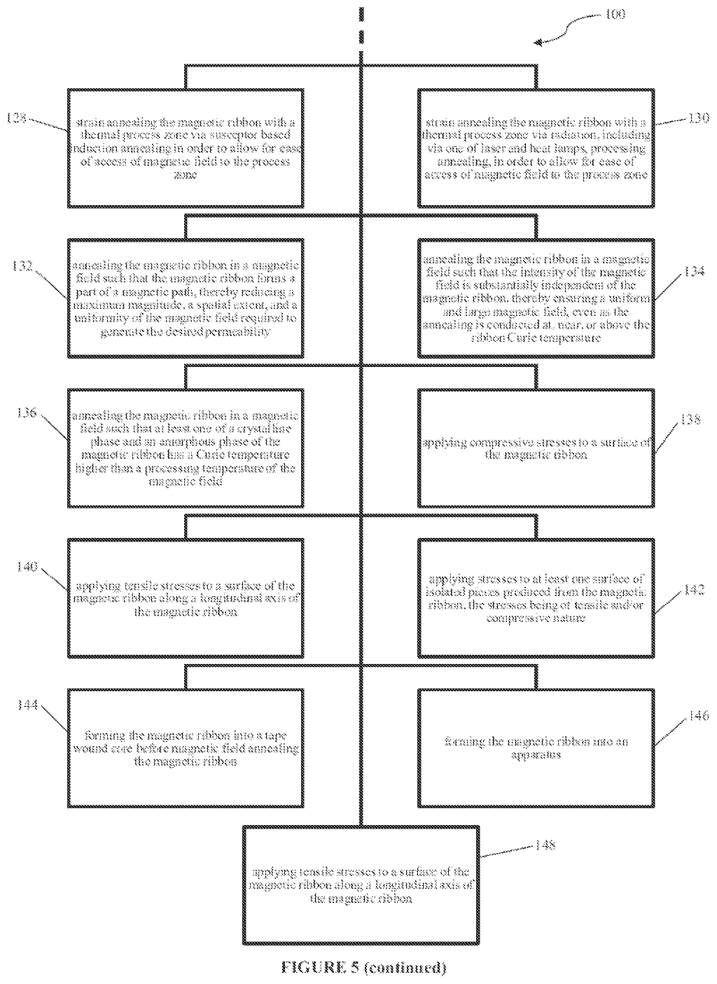

FIG. 5 is a flow chart showing various non-limiting steps for a method 100 of modifying a domain structure of a magnetic ribbon. It will be appreciated that the method 100 generally includes a step 102 of a combination of stress and magnetic field annealing the magnetic ribbon to generate a desired permeability along one or more axes of the magnetic ribbon. The step 102 may optionally include a step 104 of stress annealing the magnetic ribbon in order to generate the desired permeability along a longitudinal axis of the magnetic ribbon, and annealing the magnetic ribbon in a magnetic field along the longitudinal axis of the magnetic ribbon; a step 106 of stress annealing the magnetic ribbon in order to generate the desired permeability along a longitudinal axis of the magnetic ribbon, and annealing the magnetic ribbon in a magnetic field transverse to the longitudinal axis of the magnetic ribbon; a step 108 of annealing the magnetic ribbon in the magnetic field such that a desired material response produced by annealing the magnetic ribbon in the magnetic field is generally not collinear with the magnetic field; a step 110 of applying a manufactured die on a surface of the magnetic ribbon with a thermal expansion mismatch at elevated temperatures in order to generate a desired stress distribution and orientation dependent permeability, and annealing the ribbon in a rotating magnetic field within a plane of the magnetic ribbon; a step 112 of employing a MANC alloy material as the magnetic ribbon; a step 114 of generating the desired permeability in the magnetic ribbon such that the magnetic ribbon exhibits a nanocomposite structure following the combination of stress and magnetic field annealing; a step 116 of annealing the magnetic ribbon in the magnetic field at temperatures at or below temperatures utilized during the stress annealing in order to reduce high frequency losses by optimizing the domain structure of the magnetic ribbon without substantially affecting the desired permeability; a step 118 of annealing the magnetic ribbon in a magnetic field at temperatures above temperatures utilized during the stress annealing; a step 120 of simultaneously stress and magnetic field annealing the magnetic ribbon; a step 122 of stress annealing the magnetic ribbon with a thermal process zone via direct conduction; a step 124 of stress annealing the magnetic ribbon with a thermal process zone via convection; a step 126 of stress annealing the magnetic ribbon with a thermal process zone via induction annealing in order to allow for ease of access of the magnetic field to the process zone; a step 128 of stress annealing the magnetic ribbon with a thermal process zone via susceptor based induction annealing in order to allow for ease of access of the magnetic field to the process zone; a step 130 of stress annealing the magnetic ribbon with a thermal process zone via radiation, including via one of laser and heat lamps, processing annealing, in order to allow for ease of access of the magnetic field to the process zone; a step 132 of annealing the magnetic ribbon in a magnetic field such that the magnetic ribbon forms a part of the magnetic path, thereby reducing a maximum magnitude, a spatial extent, and a uniformity of the magnetic field required to generate the desired permeability; a step 134 of annealing the magnetic ribbon in a magnetic field such that the intensity of the magnetic field is substantially independent of the magnetic ribbon, thereby ensuring a uniform and large magnetic field, even as the annealing is conducted at, near, or above the ribbon Curie temperature; a step 136 of annealing the magnetic ribbon in a magnetic field such that at least one of a crystalline phase and an amorphous phase of the magnetic ribbon has a Curie temperature higher than a processing temperature of the magnetic field; a step 138 of applying compressive stresses to a surface of the magnetic ribbon; a step 140 of applying tensile stresses to a surface of the magnetic ribbon along a longitudinal axis of the magnetic ribbon; a step 142 of applying stresses to at least one surface of isolated pieces produced from the magnetic ribbon, the stresses being of tensile and/or compressive nature; a step 144 of forming the magnetic ribbon into a tape wound core before magnetic field annealing the magnetic ribbon; a step 146 of forming the magnetic ribbon into an apparatus; and/or a step 148 of applying tensile stresses to a surface of the magnetic ribbon along a longitudinal axis of the magnetic ribbon.

In one non-limiting embodiment of the present invention, as-cast amorphous ribbon of the composition Co_{76.4}Fe_{2.3}Mn_{2.3}Nb₄B₁₄Si₂ was annealed under tensile stress using an in-line tension controlled process. The tensile stress and ribbon speed were controlled using a control system and thermal annealing accomplished by placing a 1 ft heating zone between the unwind and rewind spools. The heating zone was controlled to a temperature of 500° C., which is less than the Curie temperature of the amorphous phase in this composition, which is approximately 560° C. The ribbon speed was 12 feet per minute. Following stress annealing at 150 MPa in air, the resulting relative permeability was approximately 50.6 as measured along the longitudinal axis. This stress annealed ribbon was then wound into a tape wound core and annealed with a magnetic field oriented transverse to the ribbon axis. A field annealing temperature of 480° C. for 4 hours in a nitrogen environment yielded a relative permeability value of 51.3 and significantly lower loss compared to the ribbon following only the stress anneal. Stress annealing at a temperature that was below the Curie temperatures of the as-cast material and the resultant phases that develop during crystallization allow for field annealing in a fixture that relies on the core as part of the magnetic circuit. Field annealing in this kind of fixture at temperatures that are higher than the Curie temperature of a phase in the material results in poor coupling of the magnetic field through the core, large dispersion in the induced anisotropy, and high core loss.

In accordance with another embodiment of the present invention, as-cast amorphous ribbon of the composition Co_{74.6}Fe_{2.7}Mn_{2.7}Nb₄B₁₄Si₂ was annealed under tensile stress using an in-line tension controlled process. The tensile stress and ribbon speed were controlled using a control system and thermal annealing accomplished by placing a 1 ft heating zone between the unwind and rewind spools. The heating zone was controlled to a temperature of 560° C., which is approximately equal to the Curie temperature of the amorphous phase in this composition. The ribbon speed was 12 feet per minute. Following stress annealing at 135 MPa in air, the resulting relative permeability is approximately 30.4, as measured along the longitudinal axis. This stress annealed ribbon was then wound into a tape wound core and annealed with a uniform 2 T magnetic field oriented transverse to the ribbon axis. A field annealing temperature of 535° C. for 4 hr in a nitrogen environment yielded a relative permeability value of 42.5, and significantly lower loss compared to ribbon following only the stress anneal. The global magnetic field applied in the second step allows for a stress annealing temperature that is similar to the Curie temperatures of the as-cast material.

Although non-limiting embodiments have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A method of modifying a domain structure of a magnetic ribbon, comprising:
a combination of stress and magnetic field annealing the magnetic ribbon in order to generate a desired permeability along one or more axes of the magnetic ribbon.

2. The method according to claim 1, wherein the combination further comprises stress annealing the magnetic ribbon in order to generate the desired permeability along a longitudinal axis of the magnetic ribbon, and annealing the magnetic ribbon in a magnetic field along the longitudinal axis of the magnetic ribbon.

3. The method according to claim 1, wherein the combination further comprises stress annealing the magnetic ribbon in order to generate the desired permeability along a longitudinal axis of the magnetic ribbon, and annealing the magnetic ribbon in a magnetic field transverse to the longitudinal axis of the magnetic ribbon.

4. The method according to claim 1, wherein the combination further comprises annealing the magnetic ribbon in a magnetic field such that a desired material response produced by annealing the magnetic ribbon in the magnetic field is generally not collinear with the magnetic field.

5. The method according to claim 1, further comprising applying a manufactured die on a surface of the magnetic ribbon with a thermal expansion mismatch at elevated temperatures in order to generate a desired stress distribution and orientation dependent permeability, and annealing the ribbon in a rotating magnetic field within a plane of the magnetic ribbon.

6. The method according to claim 5, further comprising heating the manufactured die and pressing the manufactured die into the surface of the magnetic ribbon in order to apply stress.

7. The method according to claim 1, further comprising employing a MANC alloy material as the magnetic ribbon.

8. The method according to claim 7, wherein the MANC alloy is a Cobalt-rich MANC alloy.

9. The method according to claim 1, further comprising generating the desired permeability in the magnetic ribbon such that the magnetic ribbon exhibits a nanocomposite structure following the combination of stress and magnetic field annealing.

10. The method according to claim 1, further comprising annealing the magnetic ribbon in the magnetic field at temperatures at or below temperatures utilized during the stress annealing in order to reduce high frequency losses by optimizing the domain structure of the magnetic ribbon without substantially affecting the desired permeability.

11. The method according to claim 1, further comprising annealing the magnetic ribbon in a magnetic field at temperatures above temperatures utilized during the stress annealing.

12. The method according to claim 1, further comprising simultaneously stress and magnetic field annealing the magnetic ribbon.

13. The method according to claim 1, further comprising stress annealing the magnetic ribbon with a thermal process zone via at least one of the following: direct conduction, convection, induction annealing in order to allow for ease of access of magnetic field to the process zone, susceptor based induction annealing in order to allow for ease of access of magnetic field to the process zone, via radiation processing annealing using one of laser and heat lamps in order to allow for ease of access of magnetic field to the process zone or any combination thereof.

14-17. (canceled)

18. The method according to claim 1, further comprising annealing the magnetic ribbon in a magnetic field such that the magnetic ribbon forms a part of a magnetic path, thereby reducing a maximum magnitude, a spatial extent, and a uniformity of the magnetic field required to generate the desired permeability.

19. The method according to claim 1, further comprising annealing the magnetic ribbon in a magnetic field such that the intensity of the magnetic field is substantially independent of the magnetic ribbon, thereby ensuring a uniform and large magnetic field, even as the annealing is conducted at, near, or above a Curie temperature.

20. The method according to claim 1, further comprising annealing the magnetic ribbon in a magnetic field such that at least one of a crystalline phase and an amorphous phase of the magnetic ribbon has a Curie temperature higher than a processing temperature of the magnetic field.

21. The method according to claim 1, wherein the stress annealing comprises applying compressive stresses to a surface of the magnetic ribbon.

22. The method according to claim 1, wherein the stress annealing comprises applying tensile stresses to a surface of the magnetic ribbon along a longitudinal axis of the magnetic ribbon.

23. The method according to claim 1, wherein the stress annealing comprises applying stresses to at least one surface of isolated pieces produced from the magnetic ribbon, the stresses being of tensile and/or compressive nature.

24. The method according to claim 23, further comprising developing a desired anisotropy pattern in the magnetic ribbon by sequentially treating sections of the magnetic ribbon over a surface using localized heating, varied magnitudes, directions of stresses, and magnetic fields.

25. The method according to claim 1, further comprising forming the magnetic ribbon into a tape wound core before magnetic field annealing the magnetic ribbon.

26. The method according to claim 1, wherein the desired permeability varies over a length of the magnetic ribbon.

27. A method of manufacturing an apparatus, comprising:
a combination of stress and magnetic field annealing a magnetic ribbon in order to generate a desired permeability along one or more axis of the magnetic ribbon; and
forming the magnetic ribbon into the apparatus,
wherein the apparatus is selected from the group consisting of a transformer, an inductor, a sensor, a motor rotor, and a motor stator.

28. A magnetic ribbon having a domain structure, comprising:
a MANC alloy ribbon having an anisotropic fault structure within closely packed nanocrystals of the ribbon, giving rise to a predefined permeability for excitation fields applied along a longitudinal axis of the ribbon, and another axis of permeability different than the predefined permeability, within a plane of the ribbon, and transverse to the longitudinal axis.
